(19) United States
(12) Patent Application Publication
(10) Pub. No.: US 2014/0047464 A1
(43) Pub. Date: Feb. 13, 2014

(54) METHOD AND APPARATUS FOR MEASURING TV OR OTHER MEDIA DELIVERY DEVICE VIEWER'S ATTENTION

(71) Applicants: Tsvi Chaim Lev, Tel Aviv (IL); Yuri Arshavski, Netanya (IL); Tae-Suh Park, Yongin (KR); Dan Makaranz, Beer Yaakov (IL); Yaniv Shaked, Binyamina (IL)

(72) Inventors: Tsvi Chaim Lev, Tel Aviv (IL); Yuri Arshavski, Netanya (IL); Tae-Suh Park, Yongin (KR); Dan Makaranz, Beer Yaakov (IL); Yaniv Shaked, Binyamina (IL)

(73) Assignee: SAMSUNG ELECTRONICS CO., LTD., Gyeonggi-do (KR)

(21) Appl. No.: 13/572,221

(22) Filed: Aug. 10, 2012

(51) Int. Cl. H04N 21/258

(52) U.S. Cl. 725/12

(57) ABSTRACT

A TV system with camera or any other media delivery device with camera comprising a screen and related electronics, comprises in combination: 1) Human detector suitable to determine whether one or more viewers are located in front of the screen; 2) A viewer's body pose tracker suitable to analyze a body pose and to determine whether a change has occurred in said pose; 3) An object detector suitable to detect the presence of a plurality of objects in the environment of the screen; 4) An object tracker suitable to detect a change in location of one or more objects; and 5) Logic circuitry suitable to obtain inputs from one or more detectors and trackers and to determine whether a specified condition has been reached on the basis of said inputs.

### FIELD OF THE INVENTION

The present invention relates to smart TVs. More particularly, the invention relates to a TV sets with camera or other media delivery device with camera at any given moment are described, that can change their behavior as a function of the activity that takes place in the location where they are positioned.

### BACKGROUND OF THE INVENTION

The new generation of digital TV (or other media delivery device equipped with a camera), are equipped with new capabilities that permit the development of new interactions between viewer and Multimedia Device. For the sake of brevity whenever reference is made hereinafter to “TV”, such designation is meant to indicate not only a conventional TV set, but also any device that comprises both a screen and a camera or the like imaging device.

Such interactions require a computer understanding of the viewer's behavior. For instance, a viewer may fall asleep in front of the TV, may start a phone call or be “glued” to the screen. The viewer may watch TV alone or in a group. He can be an adult, a child or an elderly person. In each of the above illustrative situations and in many others the TV, can change its behavior to adjust itself to the current situation. The reaction may be of different types, depending on the activity taking place near it and may include, e.g., changing the volume and/or brightness, switching off, or even sending to an alarm message to a designated individual. Moreover, from the commercial point of view, a detailed knowledge of the attention of the viewer estimated during a content time is important for both the content makers and the providers.

Knowing the attention level of a user requires an understanding of human body language and the recognition of different actual/external situation (phone conversation for example). The body language understanding requires an analysis of body poses, line of sight, emotion and physiology status in dynamic and static situations, as well as a learning mechanism for correcting the dynamic history of the viewer's behavior.

As stated above, in the context of this application the term “TV” refers to any device that comprises both a screen and a camera or the like imaging device. Furthermore, this term is meant to indicate all the hardware and software, whether internal to a screen on which video can be shown, or external to its, whether connected via wired or wireless connection and whether located close to the TV screen or remotely, as well as software needed to operate said harbor. Reference to any of the above, when referring to “TV” should not be taken as indicating that all existing hardware and/or software is involved in the particular function or operation described, and the skilled person will easily appreciate which elements of the TV are being referred to, without the need for repeated and lengthy description.

In one embodiment the TV device provides sophisticated functionality. For example as the modern TV may be used as teleconference device, if the user is surprised by a video call when not properly dressed, the TV device can warn the user about his clothing problem, e.g., by using an embedded software or hardware Nude Detector.

The problem of attempting to understand the behavior of a viewer has been extensively addressed in the art. US Patent Application No. 2009/0070798 (which is incorporated herein by reference its entirety) of the same inventor hereof, addresses the question of accurately recording if viewers are actually watching, listening to, interacting with, or otherwise perceiving a television, computer monitor, or the like. US Patent Application No. 2012/0057761 (which is incorporated herein by reference its entirety) also by the present inventor, addresses the three-dimensional half body pose recognition. The biomechanical model of the human upper body is described in the article “Comprehensive Biomechanical Modeling and Simulation of the Upper Body”, Sung-Hee Lee Eftychios Sifakis Demetri Terzopoulos, University of California, Los Angeles. A statistical formulation for 2-D human pose estimation from single images is presented in the article “Learning to Estimate Human Pose with Data Driven Belief Propagation”, Gang Hua Ming-Hsuan Yang Ying Wu, ECE Department, Northwestern University, Honda Research Institute

U.S. Pat. No. 7,912,246 relates to a system and method for performing age classification or age estimation based on the facial images of people, using multi-category decomposition architecture of classifiers.—The theory and practical computations for visual age classification is presented in the article “Age Classification from Facial Images” Young H. Kwon and Niels da Vitoria Loboy School of Computer Science, University of Central Florida

US Patent Application No. 2009/0285456 relates to a method and system for measuring human emotional response to visual stimulus, based on the person's facial expressions.

U.S. Pat. No. 7,895,136 proposes to connect the home or office electronic devices in a local device net. It can allow causing the devices to change to a particular state of operation to thereby perform a function desired by the user. For example, a user may be watching television (TV) when the telephone rings. The user wishes to answer the call, but to effectively communicate with the caller, the user must mute the television so that sound from the TV does not interfere with the telephone conversation. Every time a telephone call is to be answered while the user watches TV, the user must again repeat the muting process. For each call, once the user hangs up the phone, the TV must be manually unmuted so that the user can once again listen to the TV program being watched. A set of rules are learned at the one or more devices based upon observing the change of state activity. The learned set of rules is then applied at the one or more devices to automatically control changes of state of devices within the plurality of devices.

In spite of the great many attempts, prior art solutions do not solve the problem of recolonizing the behavior of a TV (with camera or other media delivery device with camera at any given moment are described) viewer in an actual, dynamic environment, which includes both body language and interaction with the environment. The viewer or group of viewers are not static objects. Every object is part of scene in dynamic development. The recognition of different features in the viewer's environment and their interactions, count, age and gender of TV viewers, different events detection and their influence to the scene, body language recognition and interpretation, head and eyes tracking of viewers, their emotional reaction understanding are very important for understanding the scene. However, prior art solutions normally deal with body language features only and do not take into account all features and their interactions, to perform global analysis of the environment.

It is therefore clear that it would be highly desirable to provide methods and apparatus that will obviate the drawbacks of the prior art, taking into account the viewer's environment.

It is another object of the invention to provide a TV set (with camera or other media delivery device with camera at any given moment are described) that will change its behavior as a function of a user's interaction with his or her environment.

Other objects and advantages of the invention will be better understood through the following description of illustrative and non-limitative embodiments.

### SUMMARY OF THE INVENTION

In one aspect the invention relates to a media delivery system equipped with a camera comprising a screen and related electronics, further comprising in combination:
i) Human detector suitable to determine whether one or more viewers are located in front of the screen;
ii) A viewer's body pose tracker suitable to analyze a body pose and to determine whether a change has occurred in said pose;
iii) An object detector suitable to detect the presence of a plurality of objects in the environment of the screen;
iv) An object tracker suitable to detect a change in location of one or more objects; and
v) Logic circuitry suitable to obtain inputs from one or more detectors and trackers and to determine whether a specified condition has been reached on the basis of said inputs.

In one embodiment of the invention the media delivery system further comprises circuitry suitable to perform one or more activities as a result of the output of the logic circuitry.

In another embodiment of the invention the one or more activities are selected from volume change, brightness change, screen switching on or off and TV set switching on or off. The one or more activities may comprise activating external systems, such as a communication system.

In one embodiment of the invention the communication system is actuated over a network. The communication system is configured to transmit a message selected from among SMS, phone message, email and Instant Messenger message.

In one embodiment of the invention the media delivery system according to claim 1, which comprises a TV set.

The invention also encompasses a method for operating a media delivery system comprising a screen and related electronics, which according to one embodiment of the invention may be a TV set, comprising:
1) Providing a human detector suitable to determine whether one or more viewers are located in front of the screen;
2) Providing a viewer's body pose tracker suitable to analyze a body pose and to determine whether a change has occurred in said pose;
3) Providing an object detector suitable to detect the presence of a plurality of objects in the environment of the screen;
4) Providing an object tracker suitable to detect a change in location of one or more objects;
5) Providing logic circuitry suitable to obtain inputs from one or more detectors and trackers and to determine whether a specified condition has been reached on the basis of said inputs and causing inputs from the detectors and trackers to be input thereto; and
6) Changing the operating status of the media delivery system according to the result of a determination of the logic circuitry as to whether a certain condition exists in the environment of the viewer, including the viewer's pose or behavior.

### BRIEF DESCRIPTION OF THE DRAWINGS

In the drawings:

FIG. 1 is a flow diagram illustrating one example of operation of a media delivery device according to one embodiment of the invention, in which the device automatically switches off when the viewer falls asleep; and

FIG. 2 is a flow diagram illustrating another example of operation of a media delivery device according to another embodiment of the invention in which the device's sound automatically switches to “mute” when a viewer initiates a phone call.

### DETAILED DESCRIPTION OF THE INVENTION

The invention integrates methods of detection and recognition of body language features, combined with external environmental features, in order to establish a system that can track a viewer's attention and perform desired actions in accordance as a result of changes in said behavior. According to the invention the analysis of the body language is performed in conjunction with a typical TV room, including the objects it contains. The invention provides for both unsupervised and semi supervised learning methods of recognition, for typical objects, such as, e.g., phone, eyeglasses, bed, armchair, table, chair, pillow, floor lamp, plate, cup, bottle, book, etc. Additional room elements that also are recognized include, for instance, surfaces such as carpet, parquet, blanket, etc.

According to the invention, in addition to the recognition of typical objects in the viewer's environment, and of the interactions between a TV (or other media delivery device with camera at any given moment are described) viewer and these objects, also the interpretation of the viewer's pose. According to the invention the TV system (or other media delivery device with camera at any given moment are described) learns the behavior of its user and his interaction with object in his environment.

The following examples will illustrate the above.

### Example 1

### Automatically Switching Off the TV Set with Camera or Other Media Delivery Device with Camera at any Given Moment are Described when the Viewer Fell Asleep

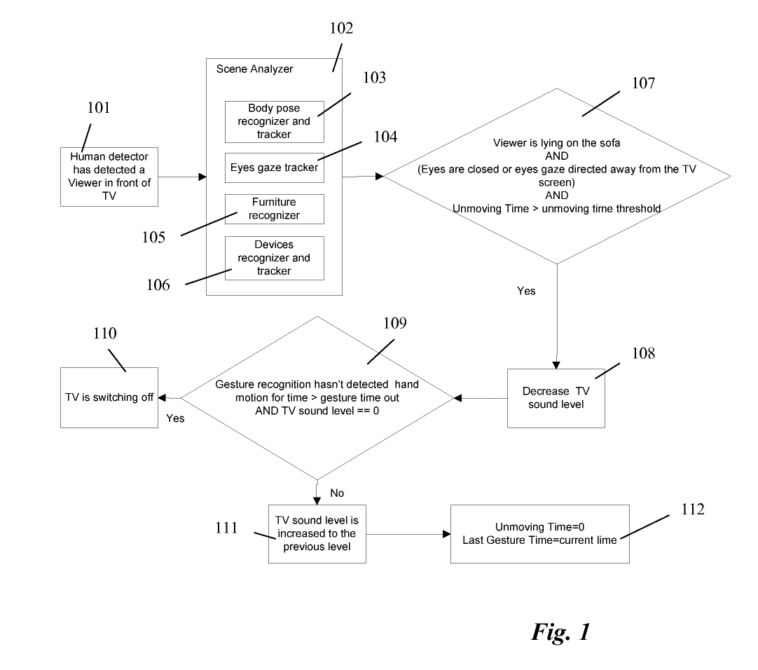

Referring to FIG. 1, the flow diagram illustrates one example of operation according to the invention. The TV set (or other media delivery device with camera at any given moment are described) is provided with a detector, indicated by numeral 101 in the figure, which may be, e.g. a camera equipped with pattern recognition software, and it detects that a viewer is positioned in front of the TV (or other media delivery device with camera at any given moment are described). Scene analyzer 102 is equipped in this example with body pose recognizer and tracker 103, with eye gaze tracker 104, with furniture recognizer 105 and with device is recognizer and tracker 106. Scene analyzer 102 analyzes all the analyzable elements of the scene and determines their condition. In the example of FIG. 1 it has determined that the viewer is lying on the sofa is eyes are either closed or directed away from the TV (or other media delivery device with camera at any given moment are described) screen and he has not moved for a period of time greater than a predetermined threshold. As a result of this determination of 107 the sound level of the TV sets (or other media delivery device with camera at any given moment are described) is decreased at 108.

In the next step, 109, the system determines whether the gesture recognition module, which may either be part of body pose recognizer and tracker 103, or can be a separate module, has not detected a motion for a time greater than a preset threshold. In the affirmative case the TV set with camera or other media delivery device with camera at any given moment are described is switched off in Step 110. In the negative case, in Step 111 the sound level of the TV set with camera or other media delivery device with camera at any given moment are described is returned to the original level. In Step 112 the system is reinitialized.

### Example 2

### TV Sound Switched to Mode “Mute”, when Viewer Started a Phone Conversation

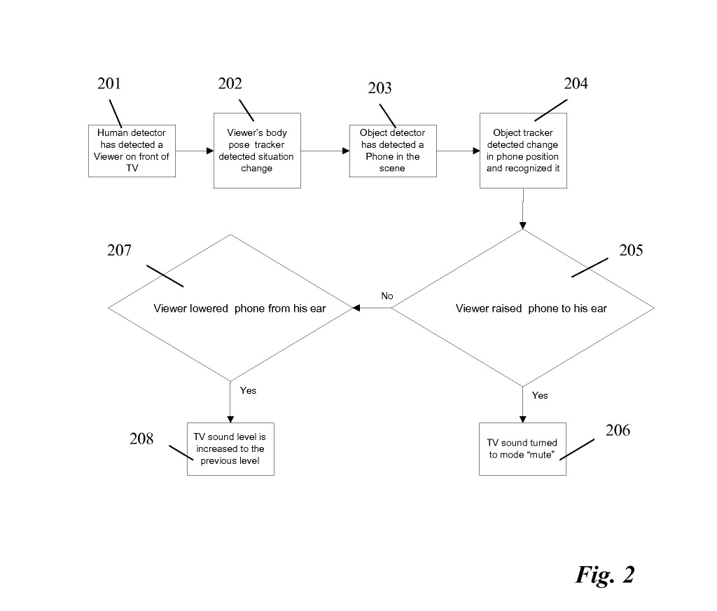

FIG. 2 illustrates a situation in which the TV set with camera or other media delivery device with camera at any given moment are described determines that a viewer has initiated a phone call. In step 201 a detector associated with the TV (or other media delivery device with camera at any given moment are described) detects that a viewer is positioned in front of the screen. In step 202 the viewer's body pose tracker determines that a change in the viewer's pose has taken place. In step 203 the object detector detects the existence of a phone in the scene, and the object tracker detects that the phone's position has changed. The combination of the above are used in step 205 to make a determination as to whether the viewer has brought the phone to his ear. If the result is positive then in step 206 the TV (or other media delivery device with camera at any given moment are described) sound is muted. If the result is negative the inputs from the detectors are used in step 207 to determine whether the viewer has lowered the phone from his ear. This analysis is performed continuously until a positive result is obtained and in step 208 the sound level of the TV (or other media delivery device with camera at any given moment are described) is increased back to the original level.

The invention comprises four main elements:

### 1. Machine Learning Methods

These methods are used for recognizing human body parts: head, face, torso, hands, and legs. These methods are also used for recognizing objects in the viewers' environment, such as phone, book, glasses, bed, armchair, table, chair, pillow, floor lamp, etc. The learning system also provides means for pose recognition (standing, sitting or lying down), gender, age and emotional status of single or multiple viewers. The learning system also provides means for recognizing typical situations (such as phone conversation, eating/drinking, writing, reading processes, etc.). The methods are well known in the art and are described, for instance, in “Machine Learning for Object Recognition and Scene Analysis” 1994, Y. Kodratoff S. Moscatelli, or “Learning Methods for Generic Object Recognition with Invariance to Pose and Lighting with Invariance to Pose and Lighting”, 2004, Yann LeCun, Fu Jie Huang, L'eon Bottou.

### 2. Real-Time Object Detecting and Tracking

The system detects and tracks both the viewer or viewers and environment objects. The system is also able to measure the position of objects and to track them, to recognize the viewer's pose, etc. Additional sensors can of course be provided in a system according to the invention to measure the level of noise, lighting, temperature and any other relevant parameters. Algorithms and methods of detection and tracking of different objects are well known in the art and are described, e.g., in “Detection, Classification and Tracking of Moving Objects in a 3D Environment”, 2012, Asma Azim and Olivier Aycard.

### 3. Real-Time Scene Understanding

The system is able to estimate and interpret viewers' actions and interactions with recognized objects. For example, using the combination of the detectors described above, in conjunction with suitable software, the system may determine that the viewer is performing a variety of activities, such as eating, writing, reading or speaking by phone. Algorithms and methods of scene understanding are well known in the art and are described, for instance, in “Scene Understanding through Autonomous Interactive Perception”, 2012, Niklas Bergstr, Carl Henrik Ek, Marten Bjorkman, and Danica Kragic.

### 4. Interaction Control

The system reacts to viewers' situation and actions, for instance by changing the sound level, or the TV (or other media delivery device with camera at any given moment are described) brightness, by switching off/on the device, by switching on/off the mute mode, by operating emergency subsystems, such as e-mail, SMS or phone calls when a certain event is detected, or by creating or changing specific computer files. The system also allows the user to predefine interaction actions or to use default settings.

Algorithms and methods of scene understanding are well known in the art and are described, for instance, in “Autonomic Management of Multimodal Interaction: DynaMo in action”, 2012, Pierre-Alain Avouac, Philippe Lalanda and Laurence Nigay.

### Use Cases Examples

Table 1 below lists a number of representative examples, which of course are not exhaustive, of actions that can be taken as a result of a specific recognized situation by a system according to the invention.

TABLE 1

| Recognized Situation | Suggested Action |
|---|---|
| The Viewer is starting/finishing a | Increase/Decrease the TV (or other |
| phone conversation | media delivery device with camera |
| | at any given moment are |
| | described) volume level or switch |
| | to mute mode |
| The room light is switched on/off | Increase/Decrease the TV (or other |
| | media delivery device with camera |
| | at any given moment are |
| | described) brightness and contrast |
| The viewer has fallen asleep in | Switch off the TV (or other media |
| front of TV (or other media | delivery device with camera) |
| delivery device with camera) (no | |
| other viewers) | |
| A child has been glued to the | Phone call/SMS or other to the |
| screen for a long time | parents |
| The viewer is reading a | Increase/decrease volume/turn off |
| book/newspaper | TV (or other media delivery |
| | device with camera) (by user's |
| | predefine choice) |
| The viewer is playing with his | Increase/decrease volume/turn off |
| smart device (tablet, phone) | TV (or other media delivery |
| | device with camera) (by user's |
| | predefine choice) |
| Nobody has been sitting on front | Switch off the TV (or other media |
| of TV (or other media delivery | delivery device with camera) |
| device with camera) for a long | |
| time | |
| Children are playing on front of | Smoothly decrease the sound |
| TV with camera or other media | volume |
| delivery device with camera at | |
| any given moment are described | |
| and don't face the display for a | |
| long time | |

As will be apparent to the skilled person the invention provides an enhanced viewer experience by exploiting state-of-the-art elements, such as embedded cameras, embedded CPU, network and phone line connections and the like. It is intended that any new defect the porous support elements that performs according to the claims below be a part of the present invention, whether existing today or developed in the future. All the above description and examples have been provided for the purpose of illustration and are not meant to limit the invention in any way except as provided for in the claims.

1. A media delivery system equipped with a camera comprising a screen and related electronics, further comprising in combination:
a) human detector adapted to determine whether one or more viewers are located in front of the screen;
b) a viewer's body pose tracker suitable to analyze a body pose and to determine whether a change has occurred in said pose by detecting and recognizing of body language features;
c) an object detector adapted to:
c.1) detect the presence of a plurality of objects in the environment of the screen;
c.2) recognize typical objects in said environment, and of the interactions between a viewer and said objects;
d) an object tracker adapted to:
d.1) track a viewer's attention by detecting a change in location of one or more objects combined with external environmental features;
d.2) measure the position of objects and to track them, to thereby recognize the viewer's pose; and
e) logic circuitry adapted to:
e.1) obtain inputs from one or more detectors and trackers;
e.2) perform interpretation of the viewer's pose by analyzing said body language features in conjunction with said objects, using both unsupervised and semi-supervised learning methods of recognition;
e.3) determine whether a specified condition has been reached on the basis of said inputs; and
e.4) perform desired actions in accordance to changes in said behavior.

2. The media delivery system according to claim 1, further comprising circuitry suitable to perform one or more activities as a result of the output of the logic circuitry.

3. The media delivery system according to claim 2, wherein the one or more activities are selected from volume change, brightness change, screen switching on or off and TV set switching on or off.

4. The media delivery system according to claim 2, wherein the one or more activities comprise activating external systems.

5. The media delivery system according to claim 4, wherein the external system is a communication system.

6. The media delivery system according to claim 5, wherein the communication system is actuated over a network.

7. The media delivery system according to claim 5, wherein the communication system is configured to transmit a message selected from among SMS, phone message, email and Instant Messenger message.

8. The media delivery system according to claim 1, which comprises a TV set.

9. A method for operating a media delivery system comprising a screen and related electronics, comprising:
a) providing a human detector suitable to determine whether one or more viewers are located in front of the screen;
b) providing a viewer's body pose tracker suitable to analyze a body pose and to determine whether a change has occurred in said pose by detecting and recognizing of body language features;
c) providing an object detector suitable to recognize objects in said environment and to detect the presence of a plurality of objects in the environment of the screen and of the interactions between a viewer and said objects;
d) providing an object tracker suitable to track a viewer's attention by detecting a change in location of one or more objects, combined with external environmental features, and to measure the position of objects and to track them, to thereby recognize the viewer's pose;
e) providing logic circuitry suitable to obtain inputs from one or more detectors and trackers and to determine whether a specified condition has been reached on the basis of said inputs and causing inputs from the detectors and trackers to be input thereto;
f) performing, by said logic circuitry, interpretation of the viewer's pose by analyzing said body language features in conjunction with said objects, using both unsupervised and semi-supervised learning methods of recognition; and
g) changing the operating status of the media delivery system according to the result of a determination of the logic circuitry as to whether a certain condition exists in the environment of the viewer, including the viewer's pose or behavior.

10. The method according to claim 9, wherein the operating status is selected from volume change, brightness change, and screen switching on or off.

11. The method according to claim 9, further comprising activating external systems.

12. The method according to claim 11, wherein the external system is a communication system.

13. The method according to claim 12, wherein the communication system is actuated over a network.

14. The method according to claim 12, wherein the communication system is configured to transmit a message selected from among SMS, phone message, email and Instant Messenger message.

15. The method according to claim 9, wherein the media delivery system comprises a TV set.
